(19) United States
(12) Patent Application Publication
(10) Pub. No.: US 2012/0062505 A1
(43) Pub. Date: Mar. 15, 2012

(54) CAPACITIVE TOUCH PANEL AND METHOD OF MANUFACTURING THE SAME

(75) Inventors: Woon Chun Kim, Gyunggi-do (KR); Yong Soo Oh, Gyunggi-do (KR); Won Ha Moon, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/978,731

(22) Filed: Dec. 27, 2010

(30) Foreign Application Priority Data
Sep. 14, 2010 (KR) 1020100089931

(51) Int. Cl. G06F 3/045; B05D 5/12; B82Y 30/00; B82Y 15/00

(52) U.S. Cl. 345/174; 427/108; 977/742; 977/952

(57) ABSTRACT

Disclosed is a capacitive touch panel, which includes a transparent substrate, transparent electrodes formed on one surface of the transparent substrate, and electrode wires formed on the other surface of the transparent substrate, wherein the transparent substrate includes through holes which are formed therethrough and are filled with a filler so that the transparent electrodes are electrically connected with the electrode wires, and in which the patterned transparent electrodes are connected with the electrode wires by the through holes formed on the transparent electrodes, thus increasing the force of adhesion between the electrode wires and the transparent electrodes, and also, the through holes are filled with a filler and thus the transparent electrodes and the electrode wires are electrically connected with each other, thus reducing contact resistance.

### CROSS REFERENCE TO RELATED APPLICATION

This application claims the benefit of Korean Patent Application No. 10-2010-0089931, filed Sep. 14, 2010, entitled “Capacitive touch panel and method of manufacturing the same”, which is hereby incorporated by reference in its entirety into this application.

### BACKGROUND OF THE INVENTION

1. Technical Field

The present invention relates to a capacitive touch panel and a method of manufacturing the same.

2. Description of the Related Art

Alongside the growth of computers using digital technology, devices assisting the computers have also been developed, and personal computers, portable transmitters and other personal information processors are used to process text and graphics using a variety of input devices such as keyboards, mouse elements and so on.

The rapid advancement of the information-based society, which is disseminating the use of computers, is being accompanied by the problems of it being difficult to efficiently operate products using only the keyboard and the mouse to perform the functions of an input device. Accordingly, the demand for devices which are simple and infrequently operate erroneously and which enable information to be easily input by anyone is increasing.

Furthermore, techniques for input devices have surpassed the mere level of fulfilling general functions and have progressed towards techniques related to high reliability, durability, innovation, designing and manufacturing. To this end, touch panels have been developed as an input device capable of inputting information such as text and graphics.

The touch panel is mounted on the display surface of an image display device such as a flat panel display including an electronic organizer, a liquid crystal display (LCD), a plasma display panel (PDP), an electroluminescence (El) element or the like, or a cathode ray tube (CRT), so that a user select the information desired while looking at the image display device.

Also, touch panels are generally classifiable as being of a resistive type, capacitive type, electromagnetic type, SAW (Surface Acoustic Wave) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, a capacitive touch panel is widely and prevalently used in different fields.

In the case where transparent electrodes are formed in the capacitive touch panel, the transparent electrodes are patterned, after which the portion other than the patterned transparent electrodes may be removed using etching or laser etching and then a silver (Ag) paste may be applied on the etched or laser etched portion in order to form electrode wires. The patterned transparent electrodes and the electrode wires made of Ag paste may be electrically connected to each other, thus completing the touch panel.

However, the conventional method of manufacturing the touch panel has many problems. First, the force of adhesion between the electrode wires and the transparent electrodes may be weak and the contact resistance may be increased. Second, the unnecessary contact area between the transparent electrodes and the wire material may increase. Third, because the Ag paste for the electrode wires should be thinly applied, a step difference may occur in a vertical direction thus deteriorating the durability of the touch panel. Fourth, in the course of curing the applied Ag paste at high temperature, the conductive polymer of the transparent electrodes may become denatured. Fifth, because the portion other than the patterned transparent electrodes is etched or laser etched in the touch panel manufacturing process, the manufacturing process may become complicated and the manufacturing cost may increase. Sixth, an etching residue may remain on the portion from which the conductive polymer was removed using etching or laser etching, and thus the electrode wires may electrically short out. Seventh, the electrode wires and the transparent electrodes are formed on the same surface, thus increasing the Bezel region of the touch panel. Eighth, because the conductive polymer of the transparent electrodes comes into direct contact with the electrode wires, electromigration may occur undesirably deteriorating the properties of the transparent electrodes.

### SUMMARY OF THE INVENTION

Accordingly, the present invention has been made keeping in mind the problems encountered in the related art and the present invention is intended to provide a capacitive touch panel and a method of manufacturing the same, which includes patterning transparent electrodes on one surface of the transparent substrate of the touch panel, forming electrode wires on the other surface of the transparent substrate, forming through holes so that the transparent electrodes are connected with the electrode wires, and filling the through holes with a filler, thus omitting the need to etch or laser etch a portion other than the patterned transparent electrodes, thereby simplifying the process of manufacturing the touch panel and solving problems that result from an etching residue being left behind after the etching or laser etching has been performed.

An aspect of the present invention provides a capacitive touch panel, comprising a transparent substrate, transparent electrodes formed on one surface of the transparent substrate, and electrode wires formed on the other surface of the transparent substrate, wherein the transparent substrate includes through holes which are formed therethrough and are filled with a filler so that the transparent electrodes are electrically connected with the electrode wires.

In this aspect, the transparent electrodes may be formed of a conductive polymer. As such, the conductive polymer may comprise poly-3,4-ethylenedioxythiophene/polystyrenesulfonate (PEDOT/PSS), polyaniline, polyacetylene or polyphenylenevinylene.

In this aspect, the filler may comprise a carbon based material, copper (Cu), gold (Au), platinum (Pt) or combinations thereof.

Furthermore, the carbon based material may comprise carbon nanotubes.

Another aspect of the present invention provides a method of manufacturing a capacitive touch panel, comprising applying a conductive polymer on one surface of a transparent substrate, forming a pattern of transparent electrodes on the conductive polymer, forming electrode wires on the other surface of the transparent substrate, forming through holes in the transparent substrate on the transparent electrodes so that the transparent electrodes are connected with the electrode wires, and filling the through holes with a filler.

In this aspect, the conductive polymer may comprise poly-3,4-ethylenedioxythiophene/polystyrenesulfonate (PEDOT/PSS), polyaniline, polyacetylene or polyphenylenevinylene.

The filler may comprise a carbon based material, copper (Cu), gold (Au), platinum (Pt) or combinations thereof.

The carbon based material may comprise carbon nanotubes.

### BRIEF DESCRIPTION OF THE DRAWINGS

The features and advantages of the present invention will be more clearly understood from the following detailed description taken in conjunction with the accompanying drawings, in which:

FIG. 1 is a perspective view showing a capacitive touch panel according to an embodiment of the present invention;

FIG. 2 is a cross-sectional view taken along the line AA′ of FIG. 1; and

FIGS. 3 to 12 are views showing a process of manufacturing the touch panel according to the embodiment of the present invention.

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

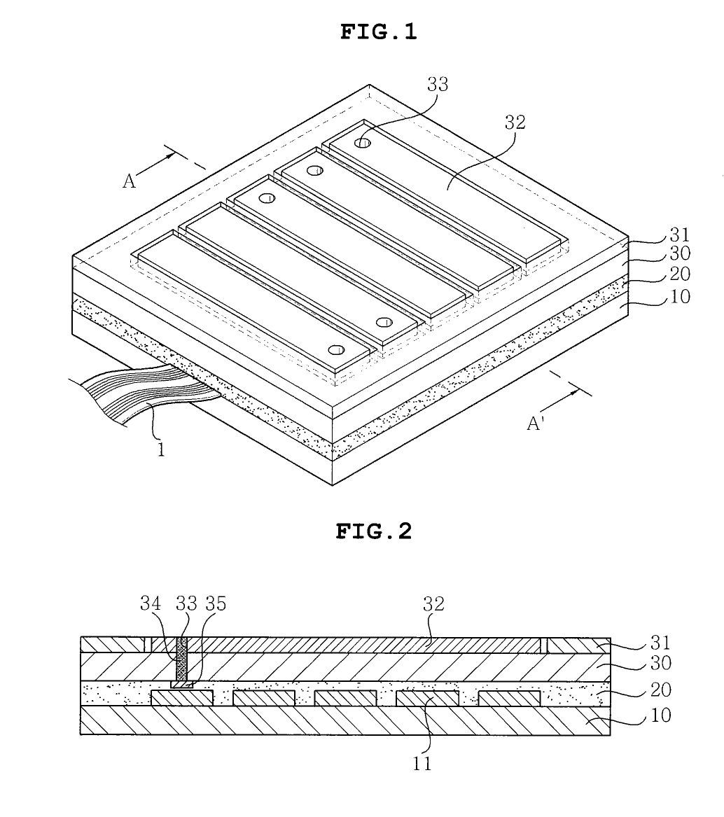

FIG. 1 is a perspective view showing a capacitive touch panel according to an embodiment of the present invention, and FIG. 2 is a cross-sectional view taken along the line AA′ of FIG. 1. The capacitive touch panel according to the embodiment of the present invention includes a transparent substrate 30, transparent electrodes 32 formed on one surface of the transparent substrate 30, and electrode wires 35 formed on the other surface of the transparent substrate 30, wherein the transparent substrate 30 includes through holes 33 which are formed therethrough and are filled with a filler 34 so that the transparent electrodes 32 are electrically connected with the electrode wires 35.

The material used for the transparent substrate 30 is not particularly limited as long as it is of at least a predetermined strength, and examples thereof include polyethyleneterephthalate (PET), polycarbonate (PC), polymethylmethacrylate (PMMA), polyethylenenaphthalate (PEN), polyethersulfone (PES), cyclic olefin copolymer (COC), TAC (Triacetylcellulose) film, polyvinyl alcohol (PVA) films, polyimide (PI) films, polystyrene (PS), biaxially oriented polystyrene (containing K resin), glass or reinforced glass. Also, because the transparent electrodes 32 are formed on one surface of the transparent substrate 30, one surface of the transparent substrate 30 may be subjected to high frequency treatment or primer treatment so as to enhance the force of adhesion between the transparent substrate 30 and the transparent electrodes 32, thus forming a surface treatment layer.

The transparent electrodes 32 function to generate signals when touched by a user so that coordinates are recognized by a controller (not shown), and are formed on one surface of the transparent substrate 30. The transparent electrodes 32 are made of a conductive polymer. Examples of the conductive polymer include but are not limited to poly-3,4-ethylenedioxythiophene/polystyrenesulfonate (PEDOT/PSS), polyaniline, polyacetylene and polyphenylenevinylene. In the present invention, the transparent electrodes 32 are connected with the electrode wires 35 by means of the through holes 33 filled with a filler 34, thus enhancing the force of adhesion between the transparent electrodes 32 and the electrode wires 35 and reducing contact resistance.

The electrode wires 35 function to transmit electrical signals between the transparent electrodes 32 and the controller (not shown), and are formed on the other surface of the transparent substrate 30. The electrode wires 35 may be electrically connected with the transparent electrodes 32 by means of the through holes 33 which will be described below. The electrode wires 35 may be formed using silk screening, gravure printing, or ink jet printing. The material of the electrode wires 35 may include Ag paste or organic Ag having high electrical conductivity, but is not limited thereto. In addition, a conductive polymer, carbon black (including carbon nanotubes), or a metal with low resistance such as a metal oxide such as ITO or metal may be used. The electrode wires 35 are electrically connected with the transparent electrodes 32 by filling the through holes 33, which are connected to the transparent electrodes 32 via the transparent substrate 30, with the filler 34. Thus, the electrode wires 35 are formed so that they are put in contact with the filler of the through holes 33.

The through holes 33 are used to electrically connect the transparent electrodes 32 with the electrode wires 35 via the transparent substrate 30, and the through holes 33 are filled with the filler 34 which is for electrically connecting the transparent electrodes 32 and the electrode wires 35. The through holes 33 may be formed at both ends in a longitudinal direction of the patterned transparent electrodes 32, thus minimizing the reduction in visibility of the touch panel, but the position of the through holes 33 is not necessarily limited thereto. The through holes 33 enable the electrical contact between the transparent electrodes 32 and the electrode wires 35, and thus the through holes 33 may be formed at the contact portion, and the formation position or number thereof is not limited thereto.

The filler 34 is charged in the through holes 33 so that the transparent electrodes 32 are electrically connected with the electrode wires 35. The case where the conductive polymer 31 is used for the transparent electrodes 32 should prevent the conductive polymer 31 from becoming denatured due to the electromigration which may occur when the conductive polymer 31 and the electrode wires 35 come into direct contact and thus are electrically connected with each other. Because the filler 34 should be able to electrically connect the transparent electrodes 32 with the electrode wires 35, it may include a carbon based material, copper (Cu), gold (Au), platinum (Pt) or combinations thereof, but is not necessarily limited thereto. The carbon based material may include carbon nanotubes (CNT) or carbon nanofiber (CNF), having excellent electron conductivity. Also, the filler 34 may be prepared in the form of a paste and charged in the through holes 33.

FIG. 2 is a cross-sectional view taken along the line AA′ of FIG. 1. As shown in FIG. 2, in the case of a two-layered capacitive touch panel, the transparent electrodes 32 and the electrode wires 35 are connected according to the present invention in any one layer, and a transparent substrate 10, transparent electrodes 11 and electrode wires may be typically formed in the other layer, and these two layers may be attached to each other using an adhesive layer 20. The material of the adhesive layer 20 is not particularly limited but may include an optical clear adhesive (OCA) in order to prevent the visibility of the touch panel from decreasing. The description that overlaps with the above description is omitted.

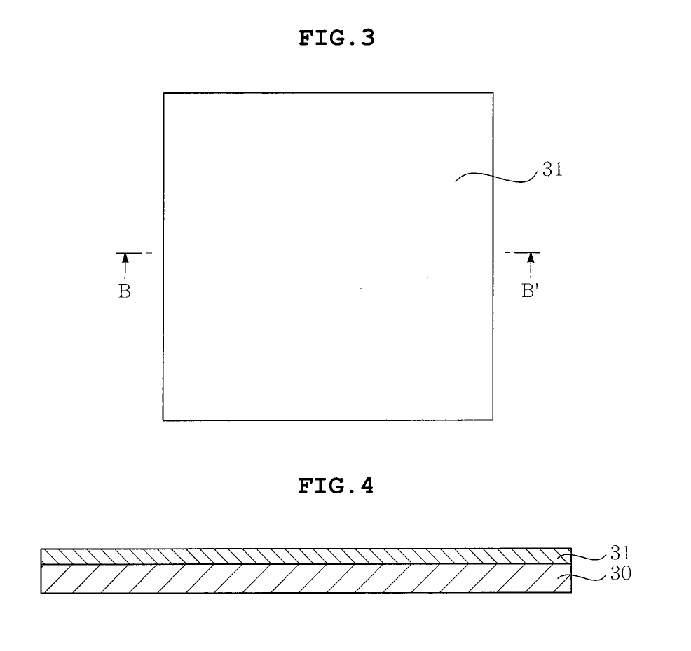

FIGS. 3 to 12 show a process of manufacturing the touch panel according to the embodiment of the present invention. With reference thereto, the method of manufacturing the capacitive touch panel according to the present invention is described below. The description that overlaps with the above description is omitted.

The method of manufacturing the capacitive touch panel according to the embodiment of the present invention includes applying a conductive polymer 31 on one surface of a transparent substrate 30, forming a transparent electrode pattern on the conductive polymer 31, forming electrode wires 35 on the other surface of the transparent substrate 30, forming through holes 33 in the transparent substrate 30 on the transparent electrodes 32 to connect the transparent electrodes 32 and the electrode wires 35, and filling the through holes 33 with a filler 34.

FIG. 3 is a top plan view showing applying the conductive polymer 31 on one surface of the transparent substrate 30, and FIG. 4 is a cross-sectional view taken along the line BB′ of FIG. 3. The conductive polymer 31 may include PEDOT/PSS, polyaniline, polyacetylene or polyphenylenevinylene, but is not necessarily limited thereto, or alternatively the other materials having the same properties may be used. In the case where the conductive polymer 31 is applied on the transparent substrate 30, it may be applied over the entire surface of the transparent substrate 30, and the conductive polymer may be etched or laser etched in a subsequent process in order to pattern the transparent electrodes 32.

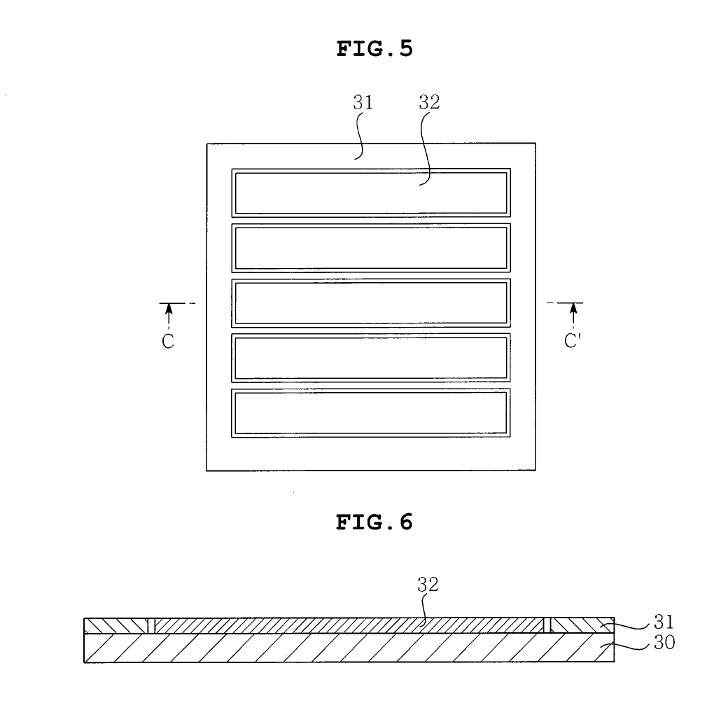

FIG. 5 is a view showing patterning the transparent electrodes 32 on the conductive polymer 31 applied on the transparent substrate 30, and FIG. 6 is a cross-sectional view taken along the line CC′ of FIG. 5. In this procedure, the pattern of the transparent electrodes 32 is formed on the conductive polymer 31. In FIG. 5, the transparent electrodes 32 may be patterned in the form of a bar according to one embodiment of the present invention. The transparent electrodes 32 are conventionally patterned in such a manner that transparent electrodes 32 are patterned and the portion other than the patterned transparent electrodes 32 is removed using etching or laser etching in order to form the electrode wires 35 at the portion where the conductive polymer 31 was removed. However, in the present invention, the transparent electrodes 32 are patterned by etching the edge of the pattern of the transparent electrodes 32 using a laser, without additionally performing removing the portion of the conductive polymer 31 other than the patterned transparent electrodes 32 using etching or laser etching. This is because the transparent electrodes 32 and the electrode wires 35 are able to be connected with each other by processing the through holes 33.

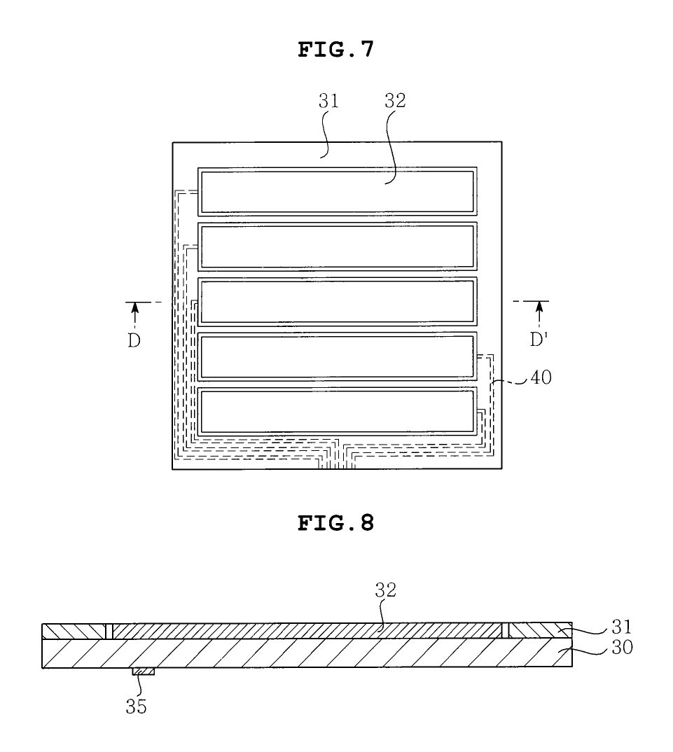

FIG. 7 is a view showing forming the electrode wires 35 on the other surface of the transparent substrate 30, and FIG. 8 is a cross-sectional view taken along the line DD′ of FIG. 7. In this procedure, the electrode wires 35 are formed on the surface of the transparent substrate 30 opposite the surface on which the transparent electrodes 32 are formed. The electrode wires 35 may be made of such materials as Ag paste or organic Ag having high electrical conductivity, and the electrode wires 35 may be formed using silk screening, gravure printing or ink jet printing.

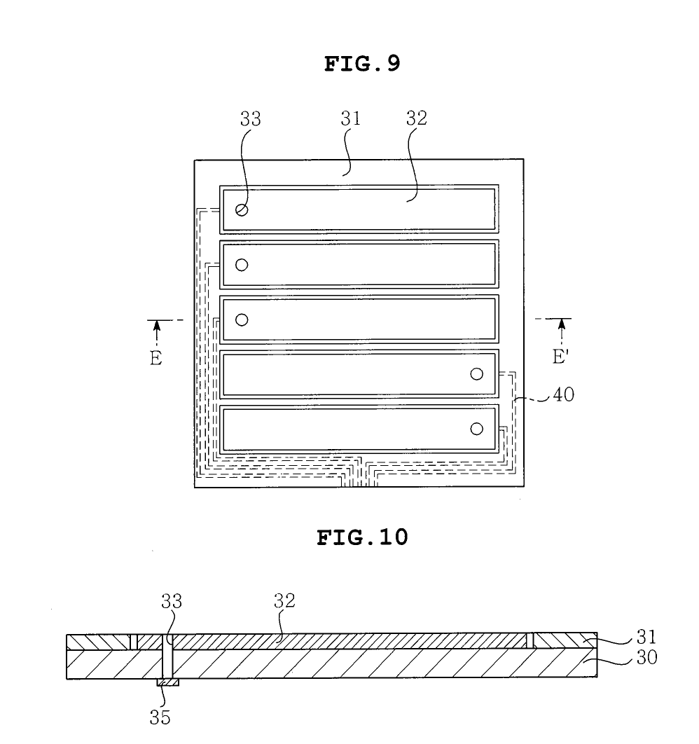

FIG. 9 is a view showing forming the through holes 33 in the transparent substrate 30 on the transparent electrodes 32 to connect the transparent electrodes 32 and the electrode wires 35, and FIG. 10 is a cross-sectional view taken along the line EE′ of FIG. 9. The through holes 33 may be formed at both ends in a longitudinal direction of the patterned transparent electrodes 32, in order to minimize the reduction in the visibility of the touch panel, but the position of the through holes 33 is not necessarily limited thereto. Furthermore, the through holes 33 may be formed at appropriate positions and in the appropriate number so that the transparent electrodes 32 are electrically connected with the electrode wires 35.

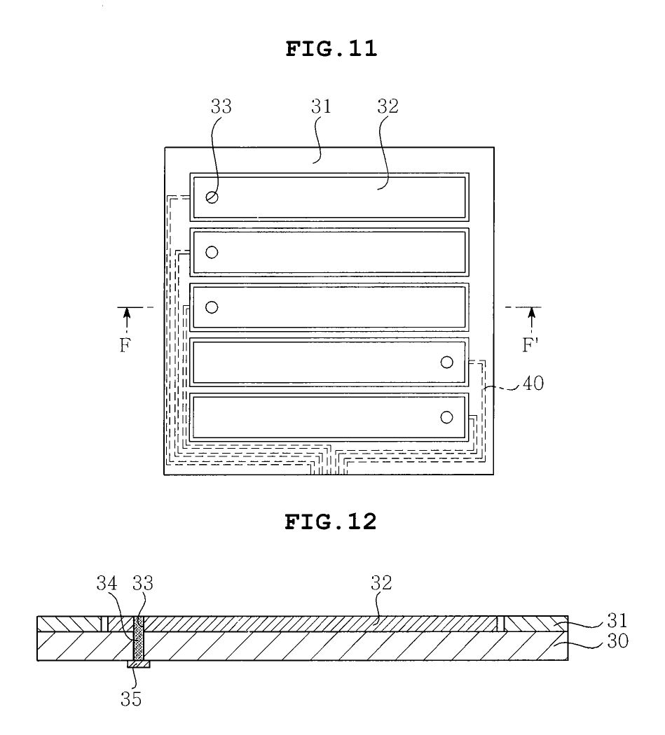

FIG. 11 is a view showing filling the through holes 33 formed on the transparent electrodes 32 with the filler 34, and FIG. 12 is a cross-sectional view taken along the line FF′ of FIG. 11. The filler 34 should be able to electrically connect the transparent electrodes 32 with the electrode wires 35, and examples thereof may include but are not necessarily limited to a carbon based material, Cu, Au, Pt and combinations thereof. The filler 34 may be prepared in the form of a paste and charged in the through holes 33.

As described hereinbefore, the present invention provides a capacitive touch panel and a method of manufacturing the same. According to the present invention, through holes are formed on transparent electrodes, so that the transparent electrodes are electrically connected with electrode wires, thus increasing contact reliability between the electrode wires and the transparent electrodes.

Also according to the present invention, the through holes are filled with a filler, so that the transparent electrodes are electrically connected with electrode wires, thus reducing contact resistance.

Also according to the present invention, the generation of step differences between the electrode wires and the transparent electrodes resulting from making the electrode wires thin using an Ag paste can be prevented, thus increasing the durability of the touch panel.

Also according to the present invention, in the course of curing the applied Ag paste at high temperature to form electrode wires, the transparent electrodes can be prevented from becoming denatured due to the high temperature.

Also according to the present invention, when the touch panel is manufactured, etching or laser etching the portion other than the patterned transparent electrodes to form electrode wires can be omitted, thus reducing the manufacturing cost and simplifying the manufacturing process, resulting in increased productivity.

Also according to the present invention, even when the portion other than the patterned transparent electrodes is etched or laser etched to form electrode wires, the electrode wires can be prevented from electrically shorting out due to an etching residue.

Also according to the present invention, the electrodes wires are formed on the surface opposite the surface on which the transparent electrodes are formed, thus minimizing the Bezel region which is an inactive region of the touch panel.

Also according to the present invention, electromigration resulting from direct contact between the conductive polymer of the transparent electrodes and the electrode wires can be suppressed, thus preventing the transparent electrodes from becoming denatured, thereby increasing operating reliability of the touch panel.

Although the embodiments of the present invention regarding the capacitive touch panel and the method of manufacturing the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A capacitive touch panel, comprising:
a transparent substrate;
transparent electrodes formed on one surface of the transparent substrate; and
electrode wires formed on the other surface of the transparent substrate,
wherein the transparent substrate includes through holes which are formed therethrough and are filled with a filler so that the transparent electrodes are electrically connected with the electrode wires.

2. The capacitive touch panel as set forth in claim 1, wherein the transparent electrodes are formed of a conductive polymer.

3. The capacitive touch panel as set forth in claim 2, wherein the conductive polymer comprises poly-3,4-ethylenedioxythiophene/polystyrenesulfonate (PEDOT/PSS), polyaniline, polyacetylene or polyphenylenevinylene.

4. The capacitive touch panel as set forth in claim 1, wherein the filler comprises a carbon based material, copper (Cu), gold (Au), platinum (Pt) or combinations thereof.

5. The capacitive touch panel as set forth in claim 4, wherein the carbon based material comprises carbon nanotubes.

6. A method of manufacturing a capacitive touch panel, comprising:
applying a conductive polymer on one surface of a transparent substrate;
forming a pattern of transparent electrodes on the conductive polymer;
forming electrode wires on the other surface of the transparent substrate;
forming through holes in the transparent substrate on the transparent electrodes so that the transparent electrodes are connected with the electrode wires; and
filling the through holes with a filler.

7. The method as set forth in claim 6, wherein the conductive polymer comprises poly-3,4-ethylenedioxythiophene/polystyrenesulfonate (PEDOT/PSS), polyaniline, polyacetylene or polyphenylenevinylene.

8. The method as set forth in claim 6, wherein the filler comprises a carbon based material, copper (Cu), gold (Au), platinum (Pt) or combinations thereof.

9. The method as set forth in claim 8, wherein the carbon based material comprises carbon nanotubes.
